(19) United States
(12) Patent Application Publication
(10) Pub. No.: US 2019/0084270 A1
(43) Pub. Date: Mar. 21, 2019

(54) TEXTILE STRUCTURE

(71) Applicant: Singular Wings Medical Co., Ltd., Hsinchu County (TW)

(72) Inventor: Chen-Hao Lee, Hsinchu County (TW)

(73) Assignee: Singular Wings Medical Co., Ltd., Hsinchu County (TW)

(21) Appl. No.: 15/849,600

(22) Filed: Dec. 20, 2017

(30) Foreign Application Priority Data
Sep. 20, 2017 (TW) 106132168

(51) Int. Cl. B32B 5/26; D04B 21/14; B32B 3/26; B32B 7/12

(52) U.S. Cl. CPC B32B 5/26; D04B 21/14; B32B 2457/00; B32B 7/12; B32B 2307/51; B32B 3/266

(57) ABSTRACT

A textile structure is provided. The textile structure includes an interior layer and an exterior layer. The interior layer includes a body portion, at least one extension portion and a first opening. The first opening is surrounded by the body portion. The at least one extension portion is extended from the body portion toward the first opening, and the first opening is covered by the at least one extension portion. The exterior layer is bonded with the body portion. A first accommodation space exists between the exterior layer and the at least one extension portion.

### CROSS REFERENCE TO RELATED APPLICATION

This application claims the priority benefit of Taiwan application serial no. 106132168, filed on Sep. 20, 2017. The entirety of the above-mentioned patent application is hereby incorporated by reference herein and made a part of specification.

### BACKGROUND

### Field of the Invention

The invention relates to a textile structure and more particularly, to a textile structure capable of being connected with an electronic device.

### Description of Related Art

A wearable device is generally composed of a micro electronic device and a carrier. For example, the carrier may include a textile or an accessory. The electronic device may be employed to record a physiological data of a wearer. The recorded physiological data may be transmitted to a processor for statistics or operations via a wired or a wireless communication manner.

Present methods for combining a textile structure and the electronic device mainly include combining the textile structure with the electronic device by a fastener piercing through the textile structure directly. In this way, the fastener will be exposed at an outer surface of the textile structure, such that an appearance of the textile structure is affected.

### SUMMARY

The invention provides a textile structure having an interior layer and an exterior layer with an accommodation space therebetween.

The invention provides a textile structure capable of being embedded with an electronic device in an accommodation space between the interior layer and the exterior layer of the textile structure.

A textile structure of the invention includes an interior layer and an exterior layer. The interior layer includes a body portion, at least one extension portion and a first opening. The first opening is surrounded by the body portion. The at least one extension portion is extended from the body portion toward the first opening and covers the first opening. The exterior layer is bonded with the body portion. A first accommodation space exists between the exterior layer and the at least one extension portion.

In an embodiment of the invention, the exterior layer further includes a second opening and a shell structure. The second opening is disposed corresponding to the first opening. The shell structure covers the second opening and has a second accommodation space.

In an embodiment of the invention, the at least one extension portion has a first elastic recovery percentage, and the body portion has a second elastic recovery percentage. The first elastic recovery percentage is greater than or equal to the second elastic recovery percentage.

In an embodiment of the invention, the exterior layer has a third elastic recovery percentage, and the third elastic recovery percentage is less than the second elastic recovery percentage.

In an embodiment of the invention, the textile structure further includes a support layer. The support layer covers a side of the at least one extension portion.

A textile structure of the invention is adapted to be electrically connected with the electronic device. The textile structure includes an interior layer, at least one fastening member, a conductive structure and an exterior layer. The interior layer includes a body portion, at least one extension portion and a first opening. The first opening is surrounded by the body portion. The at least one extension portion is extended from the body portion toward the first opening and covers the first opening. The at least one fastening member is disposed on the at least one extension portion. The conductive structure is disposed on the interior layer and electrically connected with the at least one fastening member. The exterior layer is bonded with the body portion. A first accommodation space exists between the exterior layer and the at least one extension portion. The first accommodation space is employed to accommodate the electronic device.

The textile structure of the invention can make the electronic device be embedded in the space between the interior layer and the exterior layer of the textile structure and prevent the fastening member from being exposed on an outer surface of the textile structure.

In an embodiment of the invention, the electronic device is fixed in the first accommodation space by a method of using the at least one fastening member, a friction between the electronic device and the at least one extension portion, or a combination thereof.

Based on the above, in the invention, as the interior layer of the textile structure has the body portion surrounding the first opening and the at least one extension portion with one end covering the first opening, and the body portion can be partially attached with the exterior layer, the electronic device can be accommodated and fixed in the accommodation space between the extension portion and the exterior layer. Further, in the invention, one end of the at least one extension portion is fixed, and the other end is hung over the first opening. In this way, the at least one extension portion is able to be bent, such that the electronic device can be easily installed in the accommodation space between the at least one extension portion and the exterior layer through the first opening or easily removed from the first opening. In an embodiment, the at least one fastening member is disposed on the at least one extension portion of the interior layer, thus an additional fastening member that would be disposed on the exterior layer is not required for fixing the electronic device to the textile structure. In other words, an appearance design of the textile structure can be avoided being affected by the additional fastening member or the electronic device.

In order to make the aforementioned and other features and advantages of the invention more comprehensible, several embodiments accompanied with figures are described in detail below. In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a three-dimensional (3D) exploded diagram illustrating a textile structure according to an embodiment of the invention.

FIG. 1B is an enlarged cross-sectional diagram illustrating the textile structure depicted in FIG. 1A.

FIG. 2A is a 3D exploded diagram illustrating a textile structure according to another embodiment of the invention.

FIG. 2B is an enlarged cross-sectional diagram illustrating the textile structure depicted in FIG. 2A.

### DESCRIPTION OF EMBODIMENTS

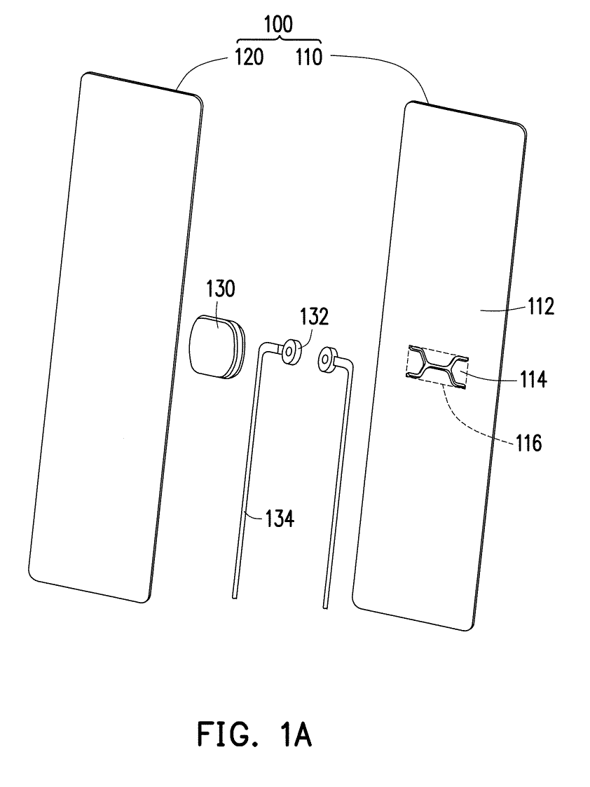

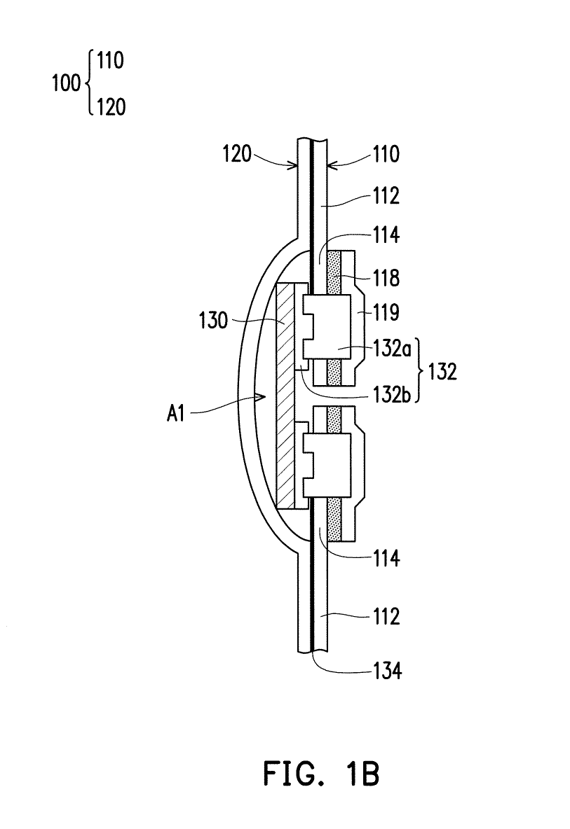

FIG. 1A is a three-dimensional (3D) exploded diagram illustrating a textile structure according to an embodiment of the invention. FIG. 1B is an enlarged cross-sectional diagram illustrating the textile structure depicted in FIG. 1A.

Referring to FIG. 1A and FIG. 1B, a textile structure 100 is a multi-layer textile structure, e.g., a double-layer textile structure. The electronic device 130 can be embedded in the textile structure 100. In the present embodiment, the textile structure 100 includes an interior layer 110 and an exterior layer 120, which are attached with each other. When the textile structure 100 is worn, the interior layer 110 may be relatively close to a wearer, while the exterior layer 120 may be relatively far away from the wearer. The textile structure 100 may be a top wear, a bottom wear, an underwear or an accessory, the invention is not limited thereto.

The interior layer 110 includes a body portion 112, at least one extension portion 114 and a first opening 116 (which is illustrated by a dashed line). The first opening 116 may be disposed at an arbitrary position on the interior layer 110, and an area of the first opening 116 may be greater than an area of the electronic device 130. However, persons with ordinary skills in the art may adjust a shape, a size and an amount of the first opening 116 according to design requirements, and the invention is not limited thereto. Edges of the body portion 112 are bonded with edges of the exterior layer 120 (for example, by means of sewing, knitting or using an adhesive). Namely, the edges of the body portion 112 and the edges of the exterior layer 120, which are bonded with each other do not have any openings.

The first opening 116 is surrounded by the body portion 112. The extension portion 114 is connected with the body portion 112. The extension portion 114 extends toward the first opening 116 and covers the first opening 116. In the present embodiment, one end of the extension portion 114 is connected with the body portion 112, while the other end is hung over the first opening 116. In this way, the extension portion 114 is able to be bent, so as to expose the first opening 116. In addition, the interior layer 110 has 2 pairs of the extension portions 114, the extension portions 114 of each pair are opposite to each other, and the extension portions 114 may be fan-shaped, a circular segment or a polygon. In an embodiment, there may be a gap, for example, a gap like an X-shape, between the extension portions 114. In another embodiment, there may be no gap between the extension portions 114. Namely, the extension portions 114 may entirely cover the first opening 116. However, the persons with ordinary skills in the art may adjust an amount, a shape and a position relationship of the extension portions according to design requirements, and the invention is not limited thereto.

The textile structure 100 of the present embodiment may further include a support layer 118. The support layer 118 covers and is attached to one side of the extension portion 114. Moreover, the support layer 118 may be extended outwards to cover a part of the body portion 112. Specifically, the support layer 118 is located on one side of the extension portion 114 which is opposite to the exterior layer 120. In an embodiment, the support layer 118 may also be located on one side of the extension portion 114 facing the exterior layer 120. The support layer 118 may be a single-layer or a multi-layer structure, and a material of the support layer 118 may be the same as or different from a material of the extension portion 114. Rigidity of the extension portion 114 may be locally increased by the support layer 118 disposed on one side of the extension portion 114, so as to reduce sway (instability) of the extension portion 114.

Referring to FIG. 1B, the exterior layer 120 is attached with an edge of the interior layer 110, and a portion of the extension portion 114 covering the first opening 116 is not attached with the exterior layer 120. In other words, the extension portion 114 is able to be bent, so as to expose the first opening 116. A first accommodation space A1 is between the extension portion 114 and the exterior layer 120. The first accommodation space A1 may be employed to accommodate the electronic device 130. The electronic device 130 may be any electronic device capable of detecting signals, recording, performing motion simulation, networking, communicating, collecting images or performing a combination of the aforementioned functions.

In addition, the extension portion 114 of the interior layer 110 has a first elastic recovery percentage, the body portion 112 has a second elastic recovery percentage, and the exterior layer 120 has a third elastic recovery percentage. In the present embodiment, the body portion 112 and the extension portion 114 may be made of the same textile, and thus, the first elastic recovery percentage is equal to the second elastic recovery percentage. In an embodiment, the body portion 112 and the extension portion 114 may be made of difference textiles, and thus, the first elastic recovery percentage may be different from the second elastic recovery percentage. On the other hand, a material with a lower elastic recovery percentage may be selected for the exterior layer 120, such that the textile structure 100 may appear to be loose, without affecting the appearance design of the textile structure 100. Further, when the textile structure 100 is worn, a material with a higher elastic recovery percentage may be selected for the interior layer 110, such that the interior layer 110 can be better fit the wearer, and better fix the electronic device 130. Furthermore, the first elastic recovery percentage of the body portion 112 and the second elastic recovery percentage of the extension portion 114 may be respectively greater than the third elastic recovery percentage of the exterior layer 120.

The textile structure 100 of the present embodiment may further include at least one fastening member 132a, and a fastening member 132b may be disposed at a surface of the electronic device 130. The fastening member 132b may be a part of a casing of the electronic device 130 or may be an additional structure attached to the casing of the electronic device 130. The fastening member 132a and the fastening member 132b may be a pair of fastening members 132 with complementary shapes and capable of being assembled to or disassembled from each other. For example, the fastening member 132a and the fastening member 132b may be a pair of a male snap and a female snap. The fastening member 132a may pass through the extension portion 114 from a side of the extension portion 114 which is opposite to the electronic device 130, so as to be combined with the fastening member 132b, and thereby, the electronic device 130 is fixed in the first accommodation space A1 between the extension portion 114 and the exterior layer 120. In another embodiment (which is not shown), the electronic device 130 may be fixed in the textile structure 100 by a friction between the electronic device 130 and the extension portion 114. For example, the friction between the extension portion 114 and the electronic device 130 may be increased by a high-friction coating layer (which is not shown) formed on a surface of the extension portion 114 which faces the electronic device 130.

In the present embodiment, the textile structure 100 may further include a covering layer 119. The covering layer 119 is disposed on a side of the interior layer 110 which is opposite to the exterior layer 120 and covers the fastening member 132b and the support layer 118. With the covering layer 119, the fastening member 132b may avoid contacting the wearer and prevent itself from conducting to another fastening member 132b. In addition, the covering layer 119 may also be employed to decorate the textile or increase wearing comfort of the textile structure 100.

The textile structure 100 of the present embodiment may further include a conductive structure 134 and a sensing electrode (which is not shown). The sensing electrode is located on the side of the interior layer 110 which is opposite to the exterior layer 120 for sensing physiological signals of the wearer. The conductive structure 134 is disposed between the body portion 112 of the interior layer 110 and the exterior layer 120 and is employed to connect the electronic device 130 and the sensing electrode, such that the physiological signals sensed by the sensing electrode can be transmitted to the electronic device 130. In an embodiment, the conductive structure 134 may also be extended on the side of the interior layer 110 which is opposite to the exterior layer 120. Specifically, the conductive structure 134 may be electrically connected with the electronic device 130 through the fastening member 132a and the fastening member 132b. In another embodiment, the conductive structure 134 may be directly and electrically connected with the electronic device 130.

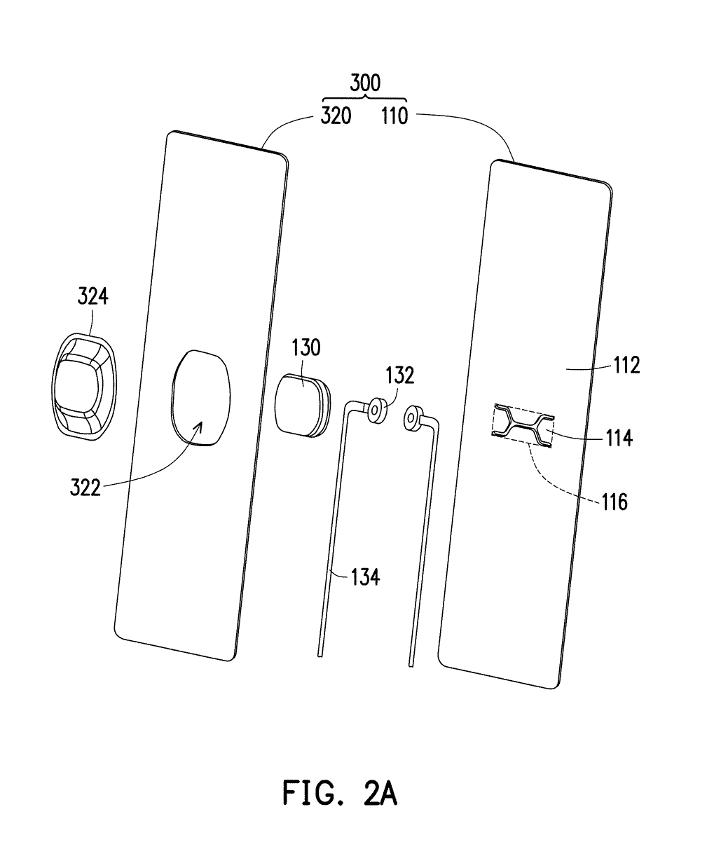

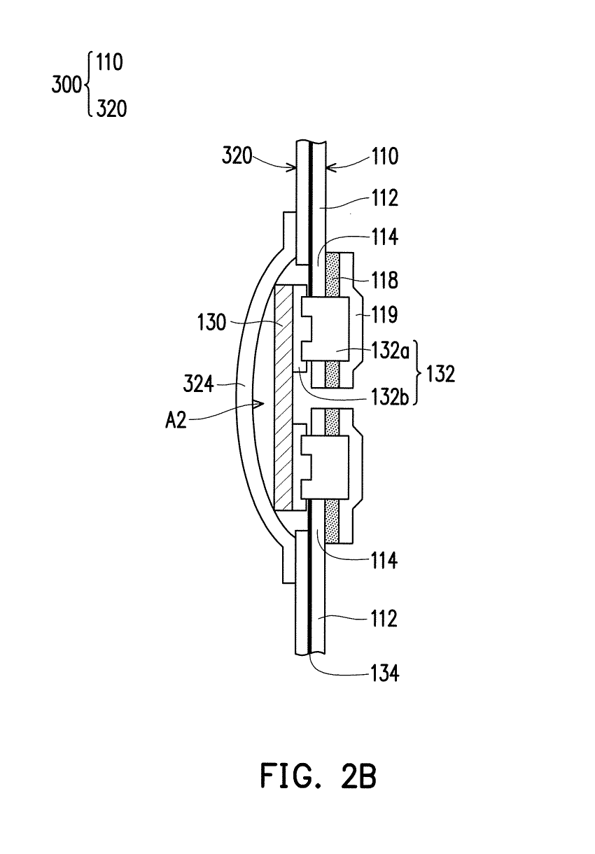

FIG. 2A is a 3D exploded diagram illustrating a textile structure according to another embodiment of the invention. FIG. 2B is an enlarged cross-sectional diagram illustrating the textile structure depicted in FIG. 2A.

Referring to FIG. 2A and FIG. 2B, a textile structure 300 of the present embodiment is similar to the textile structure 100 of the embodiment illustrated in FIG. 1A and FIG. 1B, thus, only the difference therebetween is discussed here, and the same or like parts will not be repeatedly described. An exterior layer 320 of the textile structure 300 of the present embodiment further includes a second opening 322 and a shell structure 324. The second opening 322 is configured in a manner that a position thereof corresponds to a position of the first opening 116. An area of the second opening 322 is greater than an area of the electronic device 130. Further, the area of the second opening 322 may be greater than, equal to or less than an area of the first opening 116. The shell structure 324 is attached to a side of the exterior layer 320 which is opposite to the interior layer 110. Specifically, the shell structure 324 is attached to the periphery of the second opening 322, and covers the second opening 322. The shell structure 324 protrudes toward a direction departing away from the interior layer 110. Namely, a second accommodation space A2 is formed in the shell structure 324, such that the electronic device 130 can be accommodated in the second accommodation space A2.

In light of the foregoing, in the invention, as the interior layer of the textile structure has the body portion surrounding the first opening and the at least one extension portion with one end covering the first opening, and the body portion can be partially attached with the exterior layer, the electronic device can be accommodated and fixed in the accommodation space between the extension portion and the exterior layer. In other words, the appearance design of the textile structure can be avoided being affected by the fastening member or the electronic device. Further, in the invention, one end of the at least one extension portion is fixed, and the other end of the at least one extension portion is hung over the first opening. In this way, the at least one extension portion is able to be bent, such that the electronic device can be easily installed in the accommodation space between the at least one extension portion and the exterior layer through the first opening or easily removed from the first opening. In an embodiment, the at least one fastening member is disposed on the at least one extension portion of the interior layer, thus an additional fastening member that would be disposed on the exterior layer is not required for fixing the electronic device to the textile structure. In other words, an appearance design of the textile structure can be avoided being affected by the additional fastening member or the electronic device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A textile structure, comprising:
an interior layer, comprising a body portion, at least one extension portion and a first opening, wherein the first opening is surrounded by the body portion, and the at least one extension portion is extended from the body portion toward the first opening and covers the first opening; and
an exterior layer, bonded with the body portion, wherein a first accommodation space exists between the exterior layer and the at least one extension portion.

2. The textile structure according to claim 1, wherein the exterior layer further comprises:
a second opening, disposed corresponding to the first opening; and
a shell structure, covering the second opening, wherein the shell structure has a second accommodation space.

3. The textile structure according to claim 1, wherein the at least one extension portion has a first elastic recovery percentage, the body portion has a second elastic recovery percentage, and the first elastic recovery percentage is greater than or equal to the second elastic recovery percentage.

4. The textile structure according to claim 3, wherein the exterior layer has a third elastic recovery percentage, and the third elastic recovery percentage is less than the second elastic recovery percentage.

5. The textile structure according to claim 1, further comprising a support layer, covering a side of the at least one extension portion.

6. A textile structure, adapted to be electrically connected with an electronic device, comprising:
an interior layer, comprising a body portion, at least one extension portion and a first opening, wherein the first opening is surrounded by the body portion, and the at least one extension portion is extended from the body portion toward the first opening and covers the first opening; and
at least one fastening member, disposed on the at least one extension portion;
a conductive structure, disposed on the interior layer and electrically connected with the at least one fastening member; and
an exterior layer, bonded with the body portion, wherein a first accommodation space exists between the exterior layer and the at least one extension portion, and the first accommodation space is employed to accommodate the electronic device.

7. The textile structure according to claim 6, wherein the electronic device is fixed in the first accommodation space by a method of using the at least one fastening member, a friction between the electronic device and the at least one extension portion, or a combination thereof.

8. The textile structure according to claim 6, wherein the exterior layer further comprises:
a second opening, disposed corresponding to the first opening; and
a shell structure, covering the second opening, wherein the shell structure has a second accommodation space to accommodate the electronic device.

9. The textile structure according to claim 6, wherein the at least one extension portion has a first elastic recovery percentage, the body portion has a second elastic recovery percentage, and the first elastic recovery percentage is greater than or equal to the second elastic recovery percentage.

10. The textile structure according to claim 9, wherein the exterior layer has a third elastic recovery percentage, and the third elastic recovery percentage is less than the second elastic recovery percentage.

11. The textile structure according to claim 6, further comprising a support layer, covering a side of the at least one extension portion.
